(19) United States
(12) Patent Application Publication
(10) Pub. No.: US 2015/0269316 A1
(43) Pub. Date: Sep. 24, 2015

(54) Online Referring Service Provider Portal

(71) Applicant: Universal Research Solutions, LLC, Columbia, MO (US)

(72) Inventor: Ali Adel Hussam, Columbia, MO (US)

(73) Assignee: Universal Research Solutions, LLC, Columbia, MO (US)

(21) Appl. No.: 14/218,627

(22) Filed: Mar. 18, 2014

(51) Int. Cl. G06F 19/00; G06Q 50/24

(52) U.S. Cl. CPC G06F 19/322; G06Q 50/24

(57) ABSTRACT

A computer-implemented method includes receiving a referral request to refer a consumer to one or more of an institution and a recipient service provider; obtaining, from one or more data repositories, medical information to be included in the requested type of medical record note; generating the requested type of medical record note; transmitting the referral request and the requested type of medical record note to one or more of a computing device associated with the institution and a computing device associated with the recipient service provider; and granting access to an online referring service provider portal that enables input of information related to a visit of the consumer to one or more of the institution and the recipient service provider.

### BACKGROUND

A physician refers patients to other physicians, and a medical note is a document that includes the notes of a physician.

### SUMMARY

In one aspect of the present disclosure, a method performed by one or more processing devices includes receiving, from a client device associated with a referring service provider, a referral request to refer a consumer to one or more of an institution and a recipient service provider, with the recipient service provider comprising a service provider to whom the consumer is referred; wherein the referral request specifies a type of medical record note to be transmitted to the recipient service provider; in response to the referral request, obtaining, from one or more data repositories, medical information to be included in the requested type of medical record note; generating, based on the obtained medical information, the requested type of medical record note; transmitting the referral request and the requested type of medical record note to one or more of a computing device associated with the institution and a computing device associated with the recipient service provider; and granting access to an online referring service provider portal that enables input of information related to a visit of the consumer to one or more of the institution and the recipient service provider, with the input information promoting continuity of medical care between the referring service provider and one or more of the institution and the recipient service provider. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some examples, the actions include receiving, through the online referring service provider portal, information indicative of one or more files to be uploaded to the electronic medical record of the consumer. The actions include one or more of: receiving, through the online referring service provider portal, information indicative of one or more messages to be transmitted from the recipient service provider to the referring service provider; and receiving, through the online referring service provider portal, information indicative of one or more messages to be transmitted from the referring service provider to the recipient service provider. The actions include receiving, through the online referring service provider portal, information indicative of an outcome of an evaluation of the consumer by one or more of a service provider associated with the institution and the recipient service provider; and causing an electronic medical record of the consumer to be updated with the received information. The actions include granting access to the online referring service provider portal to the referring service provider.

Receiving the referral request comprises: receiving, through the online referring service provider portal, the referral request. The actions include generating information for a graphical user interface that is displayed through the online referring service provider portal, with the graphical user interface comprising: information indicative of a listing of consumers being treated by the referring service provider; for at least one of the consumers being treated by the referring service provider, a first visual representation of a name of the least one of the consumers being treated by the referring service provider; a second visual representation of a name of a recipient service provider to whom the least one of the consumers being treated by the referring service provider is referred; and a third visual representation of an icon of a medical record note of the least one of the consumers being treated by the referring service provider, with selection of the icon causing the medical record note of the least one of the consumers being treated by the referring service provider to be displayed.

Obtaining the medical information comprises one or more of: obtaining patient reported medical information, with the patient reported medical information being based on the consumer providing answers to one or more medical questionnaires; obtaining physician reported medical information; and obtaining electronic dictation medical information that comprises medical information that is generated through speech to text software. The actions include generating information for a graphical user interface that when rendered on a client device displays: a control, selection of which causes a recordation of speech information that is dictated by a medical provider of the consumer; receiving text information that is converted from the dictated speech information and an identifier for the consumer; and causing, based on the identifier, an electronic medical record of the consumer to be updated with the received text information. The actions include generating information for a graphical user interface that when rendered on a client device displays: a visual representation of an electronic medical record of the consumer; and a control, selection of which causes (i) a recordation of dictation information that is dictated by a medical provider of the consumer, and (ii) the electronic medical record to be updated with the dictation information.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more embodiments of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a conceptual diagram of a network environment for an online service provider portal.

FIG. 2 is a block diagram of components of the online service provider portal.

FIGS. 3-11D show examples of graphical user interfaces of the online service provider portal.

FIG. 12 shows an example of a medical note.

FIG. 13 is a flow chart of an example process for generating a referral including a medical note using the online service provider portal.

### DETAILED DESCRIPTION

Described herein is a system for providing an online service provider portal.

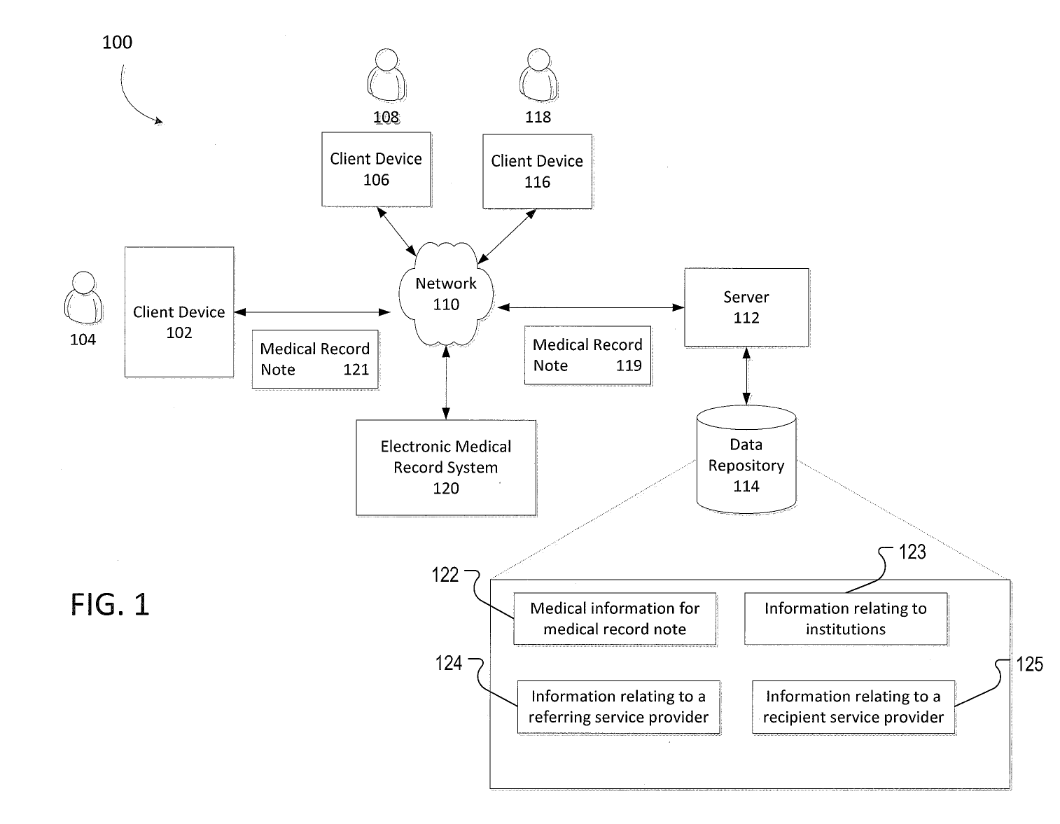

Referring to FIG. 1, system 100 includes client devices 102, 106, 116, network 110, server 112, data repository 114, and electronic medical record (EMR) system 120. In the example of FIG. 1, the server 112 is configured to generate a medical record note. Client device 102 is used by user 104, client device 106 is used by user 108, and client device 116 is used by user 118. In this example, user 104 is a referring service provider, user 108 is an institution, e.g., a hospital or clinic, and user 118 is a recipient service provider. The client devices 102, 106, 116 and the server 112 communicate with each other over network 110 and can run programs having a client-server relationship to each other. Server 112 is associated with a particular company, hospital, organization, medical institution, and so forth.

User 104 sends, to server 112, a request to refer a consumer, e.g., patient, to an institution, e.g., a hospital, or to a recipient service provider, e.g., a physician. In some examples, the user 104 also sends a request to generate a medical record note. The request may include a patient identifier. In another example, the institution 108 and/or recipient service provider 116 request a medical record note based on the referral request. In this example, server 112 obtains, from data repository 114 medical information 122 pertaining a particular patient. In an example, data repository 114 also includes information relating to the referring service provider 123, information relating to the institution 124, and/or information relating to the recipient service provider. In some cases, the information obtained from a consumers treatment and outcome related metrics can also be stored as information relating to institutions and/or information relating to recipient service providers.

In another example, server 112 obtains a medical record note 121 from the EMR system 120. In this example, the EMR system is configured to store medical record notes for various patients.

The server 112 sends the medical record note 119, 121 to the client device 106, 116 for presentation to the user 108, 118. After being presented with the medical record note, the user 108, 118 sends to the server 112, data pertaining to the medical evaluation of the patient. The user 108, 118 may enter the data into a predefined data field of the medical note 119, 121, or the data may indicate a selection of a selectable field of the medical note 119, 121.

In some examples, the user 108, 118 may enter data by speaking into a microphone included or connected with the client device 106, 116. In this example, the server 112 includes a speech recognition module to translate the words spoken by the user 108, 118 into text for populating a data field of the template medical record note 119, 121.

In response to receiving the data entered by the user 108, 118, the server 112 populates the corresponding portions of the medical record note 119, 121 with the received data. When the user 104 has finished entering data using the medical record note 119, 121, the user 108, 118 sends to the server 112 an indication that the user 108,118 has finished entering medical data. Upon receiving the indication, the server 112 may determine whether all portions of the medical record note 119, 121 have been completed. The system 112 may notify the user 108, 118 when the server 112 determines that the user 108, 118 has failed to complete a portion of the medical record note.

In an example, one or more medical notes 119, 121 are associated with medical note codes. Server 112 uses the medical codes included in the referral medical note request to identify which medical note is requested. The server 112 may identify medical notes based on matches and/or similarities among medical codes in the EMR record system 120.

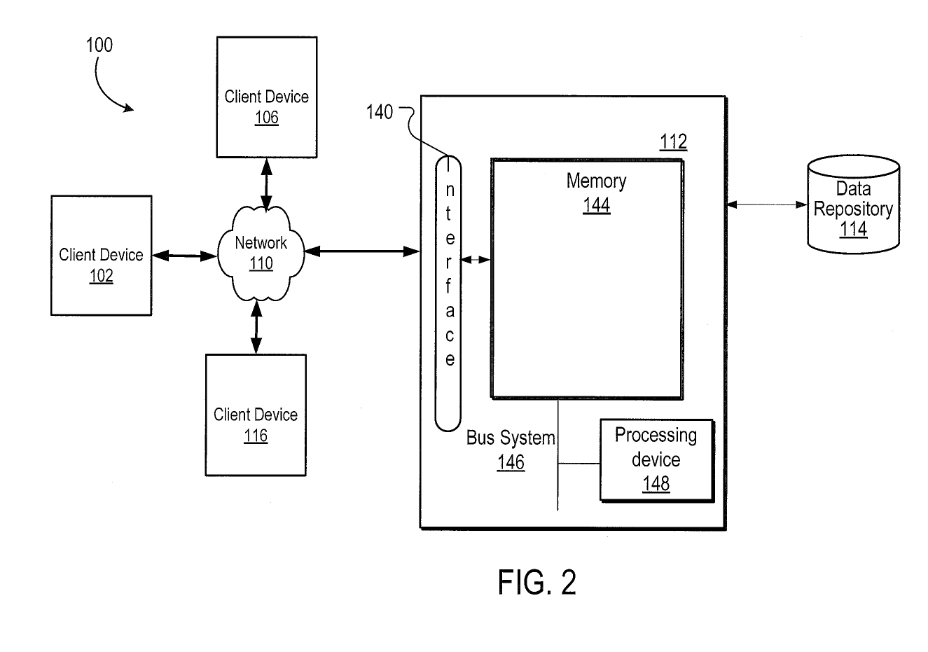

FIG. 2 is a block diagram of components of the network environment 100 for providing an online service provider portal. In FIG. 2, client devices 102, 106, 116 can be any sort of computing devices capable of taking input from a user and communicating over network 110 with server 112 and/or with other client devices. For example, client device 102 can be mobile devices, desktop computers, laptops, cell phones, personal digital assistants (“PDAs”), iPhone, smart phones, iPads, servers, embedded computing systems, and so forth. Server 112 also includes memory 144, a bus system 146, and a processor 148.

Memory 144 can include a hard drive and a random access memory storage device, such as a dynamic random access memory, machine-readable media, machine-readable hardware storage devices, or other types of non-transitory machine-readable storage devices. A bus system 146, including, for example, a data bus and a motherboard, can be used to establish and to control data communication between the components of server 112. Processor 148 may include one or more microprocessors and/or processing devices. Generally, processor 148 may include any appropriate processor and/or logic that is capable of receiving and storing data, and of communicating over a network (not shown).

Server 112 can be any of a variety of computing devices capable of receiving data, such as a server, a distributed computing system, a desktop computer, a laptop, a cell phone, a rack-mounted server, and so forth. Server 112 may be a single server or a group of servers that are at a same location or at different locations. The illustrated server 112 can receive data from client devices 102 via input/output (“I/O”) interface 140. I/O interface 140 can be any type of interface capable of receiving data over a network, such as an Ethernet interface, a wireless networking interface, a fiber-optic networking interface, a modem, and so forth.

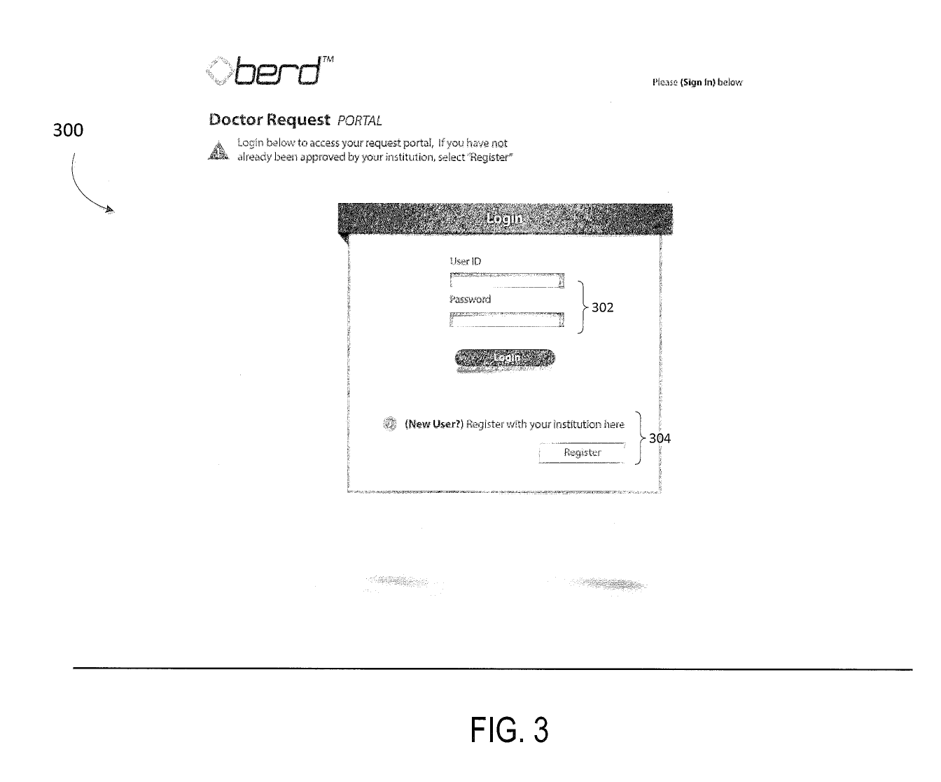

Referring now to FIG. 3-11D, server 112 generates information for one or more graphical user interfaces that provide information to a user of the online service provider portal system 100. In general, this information can be medical information 122, information relating to a referring service provider 123, information relating to an institution 124, and information relating to a recipient service provider 125.

In general, the graphical user interfaces can be rendered by an application installed on a client device 102, 106, 116 as part of execution of the application. In an example, the graphical user interfaces can be rendered by an application that when executed generates the graphical user by loading graphical resources stored on the client device 102, 106, 116 and installed as part of the installation of the application. In another example, the graphical user interfaces can be generated by a browser-based application that generates that graphical user interfaces by receiving and interpreting information indicative of one or more web pages.

Referring now to FIG. 3, a screen image of a graphical user interface 300 is shown that may be presented as a login screen. In an example, the graphical user interface 300 can be presented when a user first executes an application that can interface with the online service provider portal system 100 (FIG. 1). In particular, the graphical user interface 300 includes a login field 302, in which the user can input a user ID and password that is associated with the registered user. If the user is not yet a registered user, graphical user interface 304 includes a registration field 304.

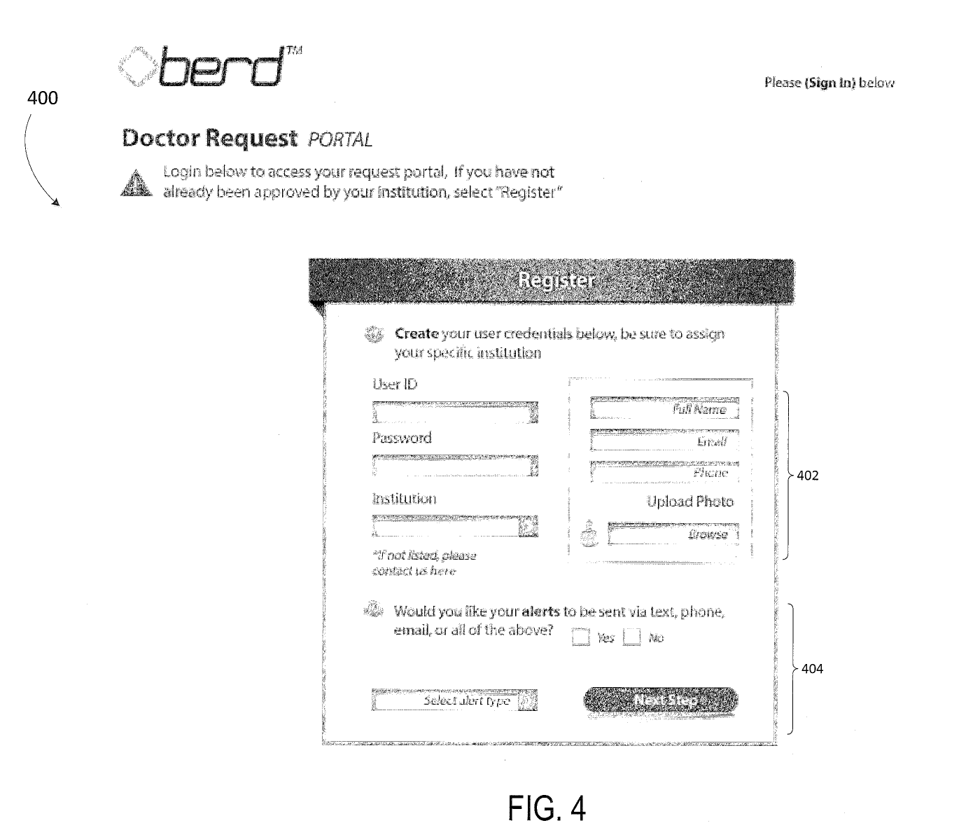

Referring now to FIG. 4, a screen image of a graphical user interface 400 is shown that may be presented to a user attempting to register. In particular, the graphical user interface 400 includes fields for entering various login credentials 402. In particular, various login credentials can include a User ID, Password, Institution, Full Name, E-Mail, Phone Number, a picture of the doctor, and so forth. In an example, the graphical user interface 400 also includes alert preferences 404. In particular, a user indicates whether the user desires to receive alerts via text, phone, and/or email by selecting the user's alert preferences 404.

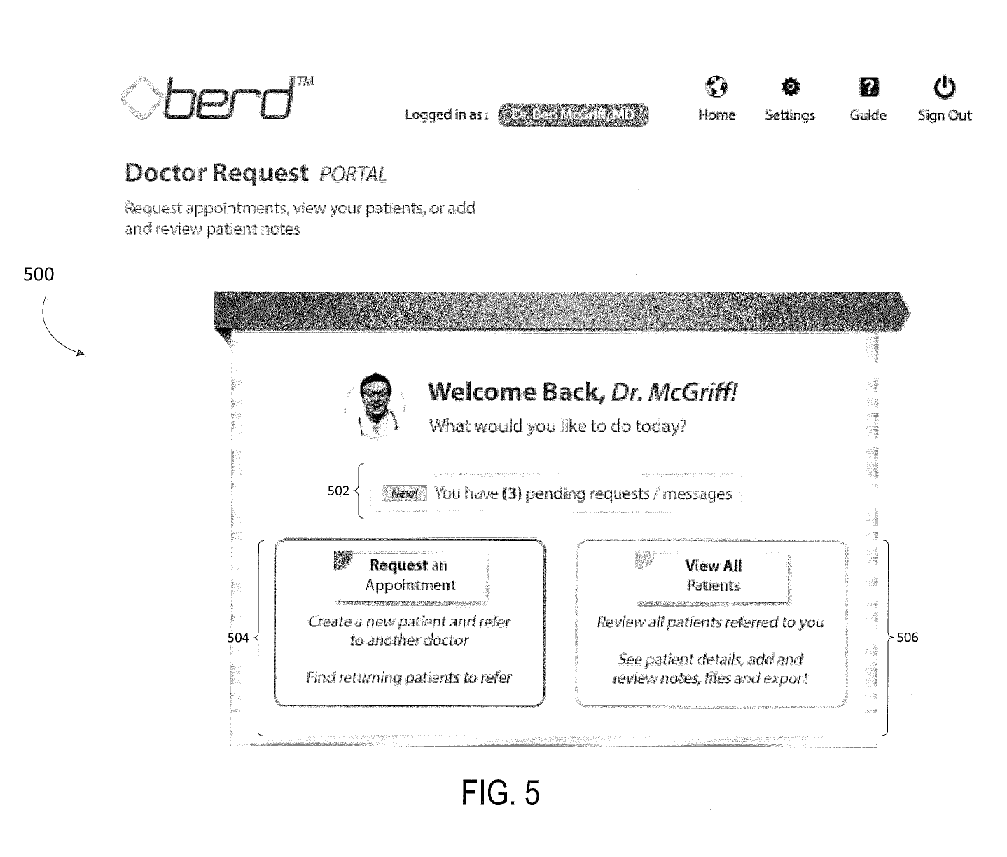

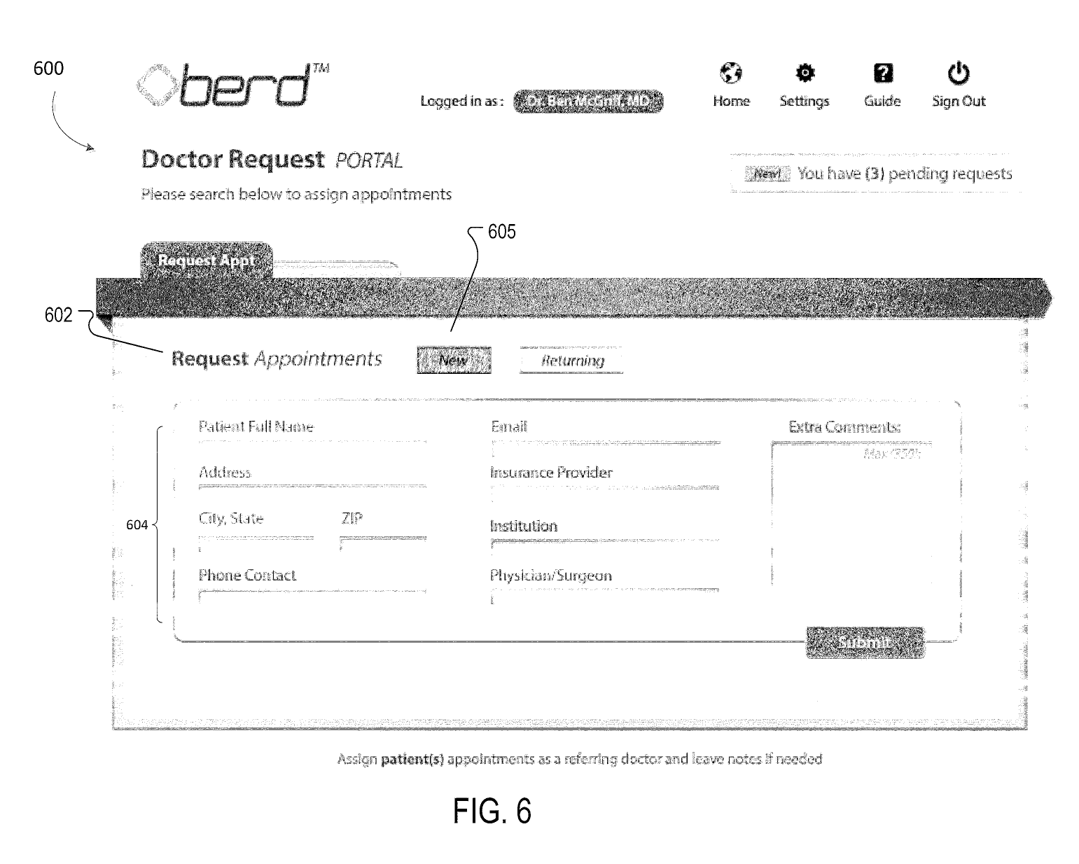

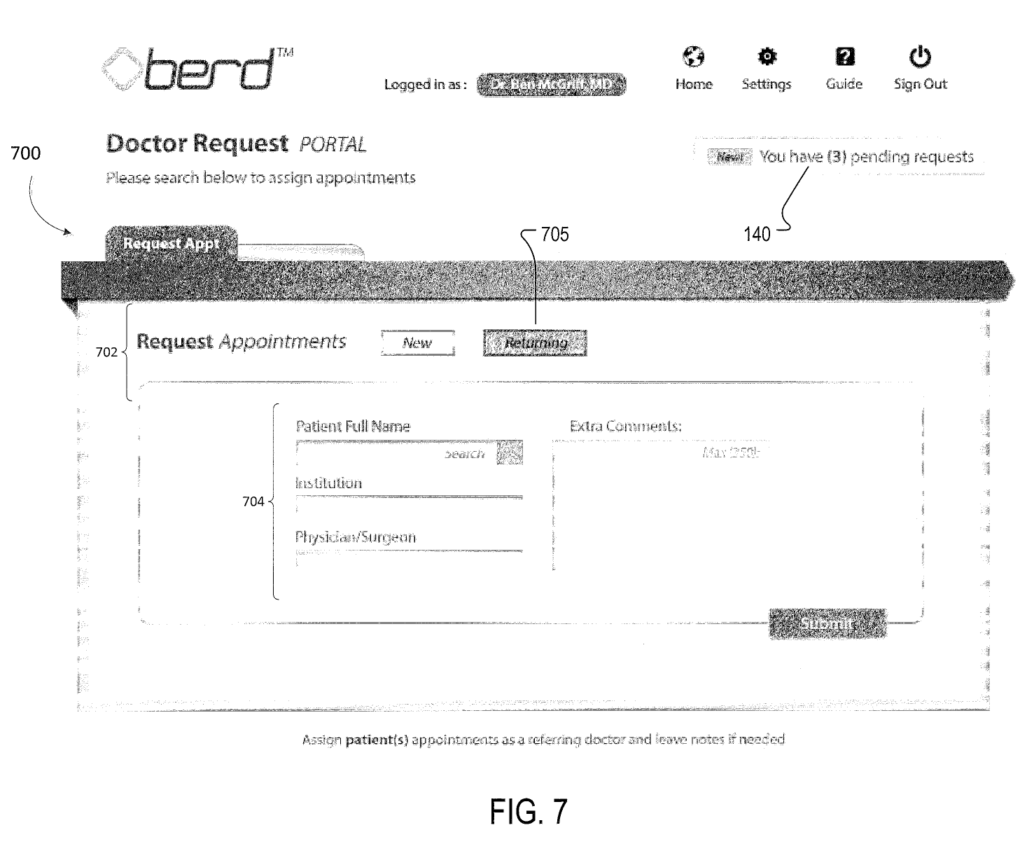

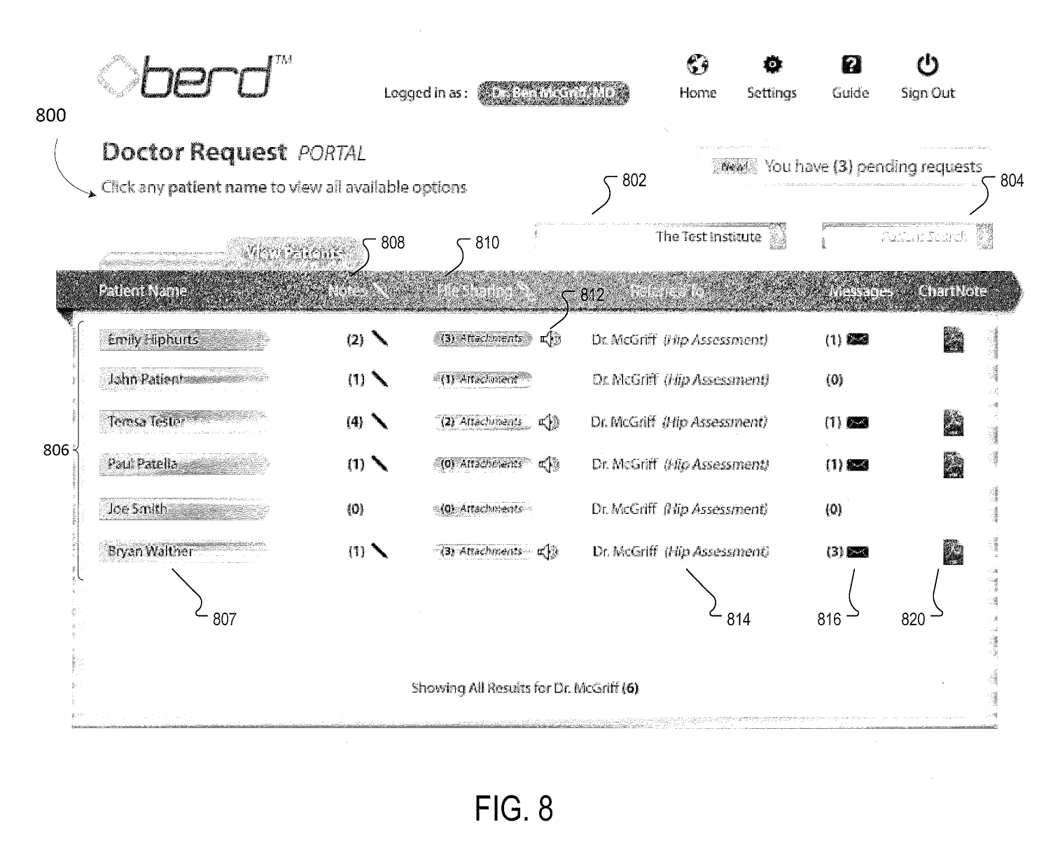

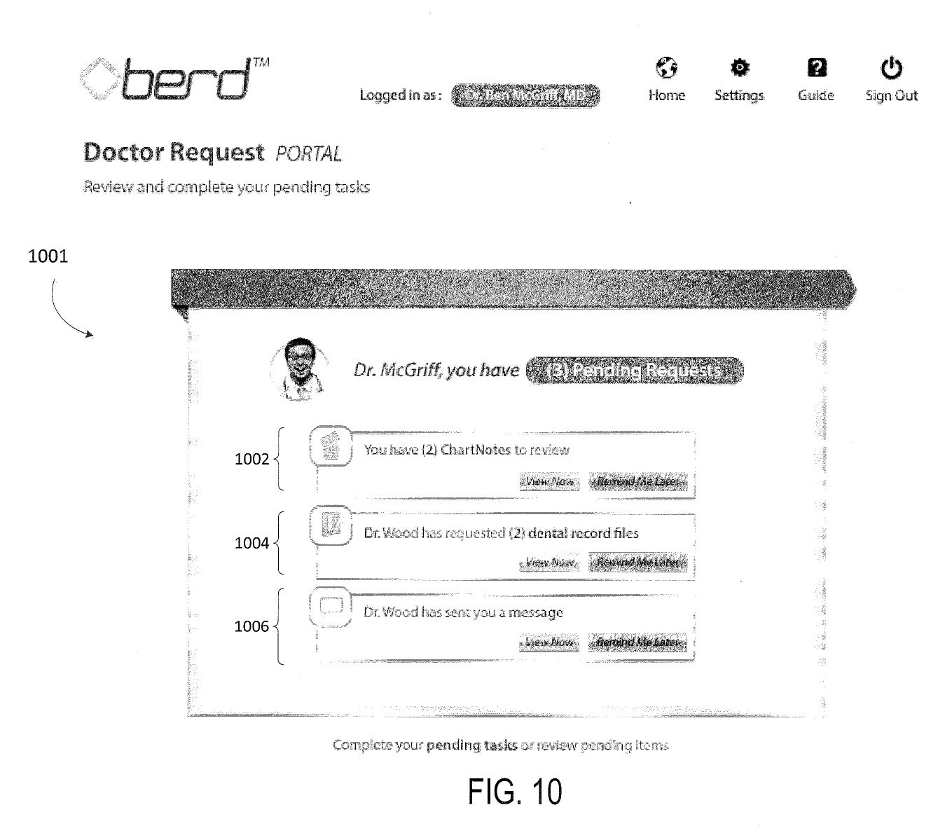

Referring now to FIG. 5, a screen image of a graphical user interface 500 is shown that may be presented as a home screen or other initial landing screen for a registered user. Graphical user interface 500 includes a notification field 502 that notifies the registered user of any pending referral requests and/or messages. In this example, the notification field includes a selectable link that a registered user can select to cause server 112 to display any pending requests/referrals (as shown in FIG. 10). The graphical user interface 500 also includes a “Request an Appointment” field 504. In this example, the Request an Appointment field 504 includes a selectable link that a registered user can select to cause server 112 to display an appointment request graphical interface (as shown in FIGS. 6 and 7). The graphical user interface 500 also includes a “View All Patients” field 506. In this example, the View All Patients field 506 includes a selectable link that a registered user can select to cause server 112 to display information indicative of all patients associated with the registered user (as shown in FIG. 8.)

Referring now to FIG. 6, a screen image of a graphical user interface 600 is shown that can be used to request appointments for new patients. The graphical user interface 600 includes an appointment request field 602 and patient data fields 602. In this example, the appointment request field 602 includes a selectable link that a registered user can select to cause server 112 to display the patient data fields 604. In this example, the registered user has indicated that the patient is a “New” patient 605 and patient data fields 604 include patient full name, address, city, state, zip, phone contact, email, insurance provider, institution, physician/surgeon, extra comments, and so forth. This patient data is stored on the system for association with any future medical information.

Referring now to FIG. 7, a screen image of a graphical user interface 700 is shown that can be used to request appointments for returning patients. In this example, the appointment request field 702 includes a selectable link that a registered user can select to cause server 112 to display the patient data fields 704. In this example, the registered user has indicated that the patient is a “Returning” patient 705 and patient data fields 705 include patient full name, institution, physician/surgeons, extra comments, and so forth. Server 112 is able to access any medical information associated with the patient name previously stored on the system.

Referring to FIG. 8, a screen image of a graphical user interface 800 is shown that can be used to display the referrals requested by the registered user. Graphical user interface 800 includes institution search field 802, patient search field 804, and patient result fields 806. The patient results fields 806 include a patient field 807, a notes field 808, a file sharing field 810, an audio file field 812, a referral summary field 814, a message field 816, and a medical note field 820. In this example, patient results field 806 includes all pending referrals associated with the registered user and the institution specified in the intuition search field 802, e.g., “The Test Institute.” Generally, each patient 807 is listed associated with a notes field 808, file sharing field 810, audio file field 812 referral summary 814, a message field 816, and a medical note field 820. Each respective field includes a summary of the number of available documents. For example, as shown in FIG. 8, patient Emily Hiphurts is referred to Dr. McGriff for a hip assessment and Emily Hiphurts is associated with at least two notes, at least three files, at least one audio file, at least one message, and at least one medical note. In another example, as shown in FIG. 8, John Patient is referred to Dr. McGriff for a hip assessment, and John Patient is associated with at least one note, and at least one attachment. Each field patient results field 806, for example, patient field 807, notes field 808, file sharing field 810, audio file field 812, referral summary field 814, message field 816, and medical note field 820, includes a selectable link that a registered user can select to cause server 112 to display the data associated with the respective field. For example, if the user selects the text and/or icon in the medical note field, the user will cause server 112 to display all notes associated with the patient.

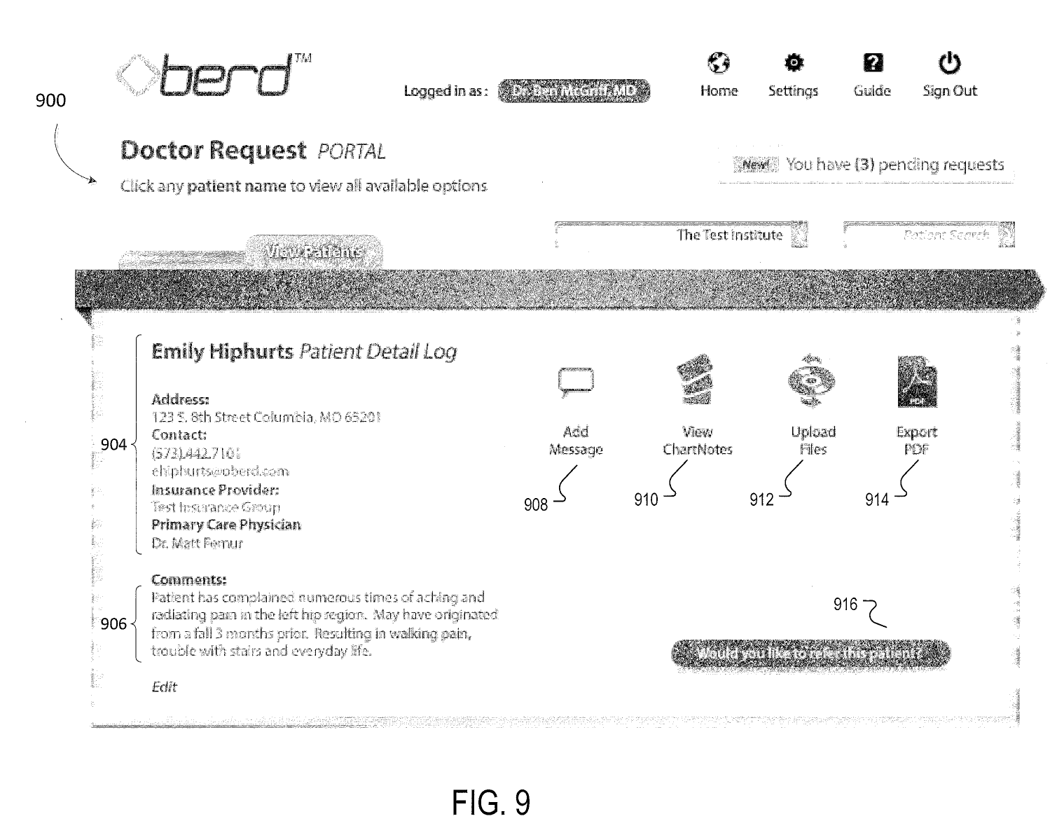

Referring to FIG. 9, a screen image of a graphical user interface 900 is shown that displays a patient detail log pertaining to a selected patient. Graphical user interface 900 includes patient information summary 904, a physician comment field 906, an add message field 908, a view medical notes field 910, an upload files field 912, an export pdf field 914, and a referral field 916. In an example, at least one field, e.g. the physician comment field 906, the add message field 908, the view medical notes field 910, the upload files field 912, the export pdf field 914, and the referral field 916, includes selectable links that a register user can select to cause the server 112 to display the data associated with each respective field.

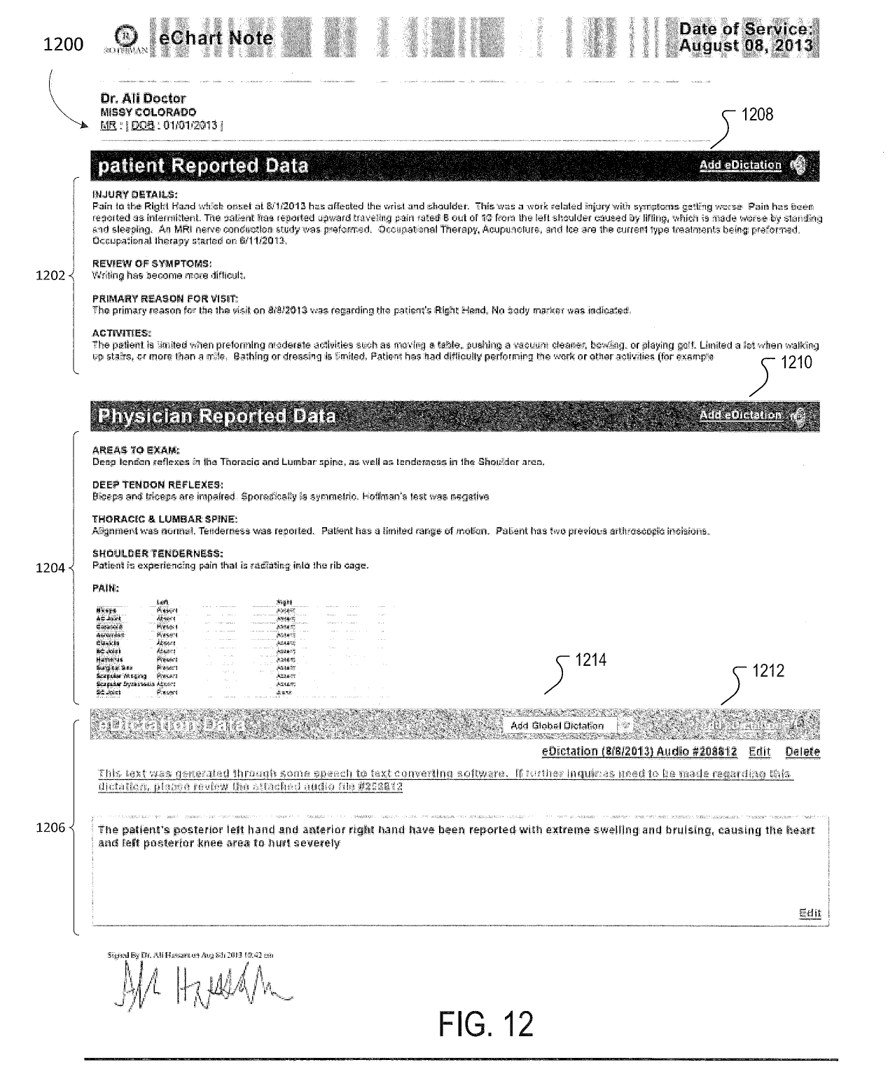

In some examples, the registered user selects the add message 908 text and/or icon to add a message associated with the patient. In this example, the registered user selects the add message field 908 and causes server 112 to display a text field in which the registered user enters a message. This message is associated with the patient. In some examples, the message is displayed as shown in FIG. 8, e.g., in the message field 816. In other examples, the registered user is notified of a new message, as shown in FIG. 5, via the notification field 502. In another example, the registered user selects view medical notes 910 to view medical notes associated with the patient. An example of a medical note is shown in FIG. 12 and discussed below. In another example, the registered user can select upload files 912. In this example, the selection causes server 112 to display a dialog box in which the user selects a specific file to upload and associate with the patient. In other examples, the registered user selects the export pdf 914 link. In this example, the selection causes server 112 to display a dialog box in which the user selects either a portion of or the entirety of data associated with the patient to save locally.

In other examples, the registered user selects the request referral 916 text and/or icon to refer the patient to another service provider and/or institution. In this example, the registered user selects the request referral field 916 and causes server 112 to display a prompt similar to that shown in FIG. 7 in which the “Patient Full Name” field is pre-populated with the patient name displayed in the patient information summary 904.

Referring to FIG. 10, a screen image of a graphical user interface 1001 is shown that displays any pending requests associated with the registered user. Graphical user interface 1001 includes a medical note review field 1002, a pending request field 1004, and a received message field 1006. In this example, the medical note review field 1002, the pending request field 1004, and the received message field 1006 each include a selectable text and/or icon, e.g., “View Now,” that a registered user can select to cause server 112 to display any pending requests, medical notes, or messages. In other examples, the registered user can select the selectable text and/or icon, e.g., “Remind me Later,” to view these requests at a later time.

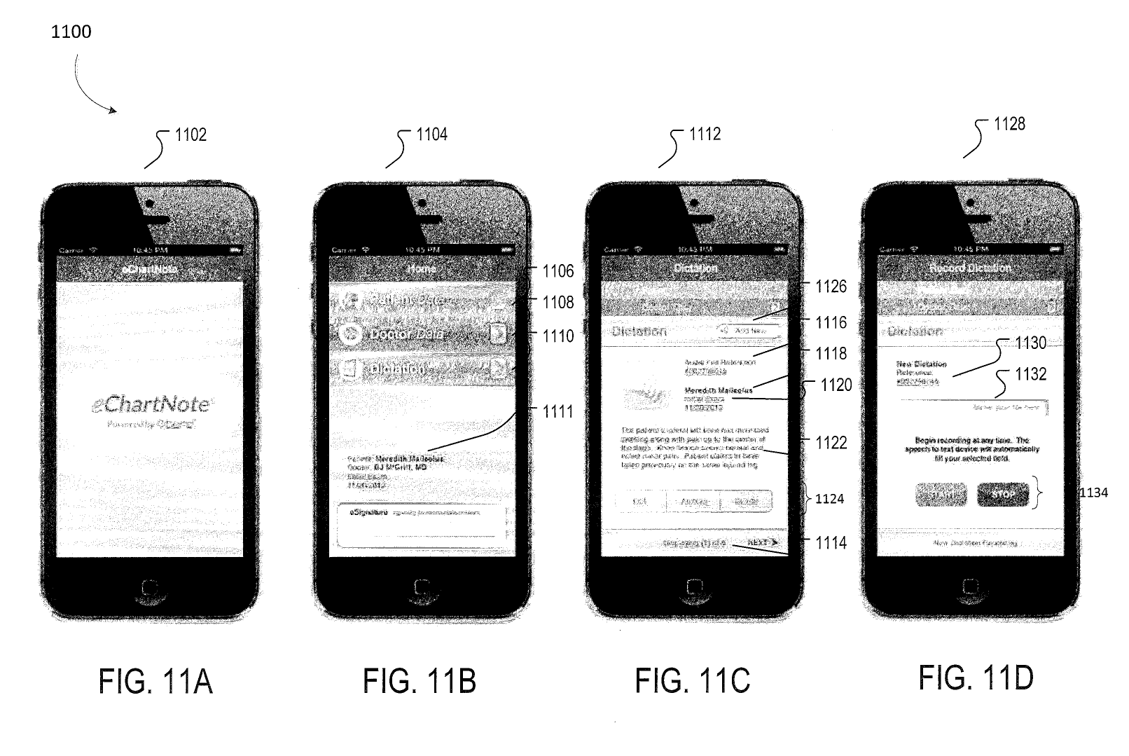

Referring to FIGS. 11A-11D, a series of screen images of a graphical user interface 1100 is shown that can be used to access the online service provider portal from a client device and/or to upload a patient note (or a medial note) to the online service provider portal. In this example, a screen image 1102 is presented as an initial landing screen and/or home screen for a registered user. From this initial screen, a registered user may navigate to a login-in screen (not shown) and to a home screen 1104. The home screen 1104 includes selectable fields relating to patient data 1106, doctor data 1108, and dictation information 1110. In some examples, a registered user can select a patient from the system as indicated by patient identifier 1111. Once a patient is selected, data pertaining to the patient is accessible and/or can be entered into the system. For example, the registered user can select the dictation field 1110 to cause server 112 to display a dictation screen 1112. The dictation screen 1112 can display all dictation entries associated with the selected patient either on the dictation screen 1112 or accessible via a navigation tab 1114. In some examples, the dictation screen 1112 can include any of the following: an audio file reference identifier 1116, a patient identifier 1118, a brief description 1120 of the subject matter of the dictation, a text box displaying text generated from the recorded dictation 1122, and a management tab 1124 including options to edit the entry, archive the entry, and/or delete the entry. In some examples, the registered user can navigate to a different dictation entry via the navigation tab 1114. In other examples, the registered user selects “Add New” text and/or icon 1126 to navigate to a new dictation screen 1128.

In certain examples, the new dictation screen 1128 includes any of the following: an audio file reference number 1130, an entry description field 1132, and a control field 1134. In this example, the audio file reference number 1130 is automatically generated by server 112. The registered user enters a brief description of the dictation file in the entry description field 1132 and selects the “Start” text and/or icon from the control field 1134 to begin recording and selects the “Stop” text and/or icon from the control filed 1134 to end recording. After the registered user ends the recording, server 112 stores the audio file and converts the substance of the audio file to text that is associated with the patient. The text of a dictation is accessible as a textbox 1122 or in a medical note, as described below.

FIG. 12 shows an example of a medical note 1200 generated by server 112 and that is accessible through the portal. In the example of FIG. 12, the medical note 1200 includes information relating to patient reported data 1202, information relating to physician reported data 1204, and information relating to dictation data 1206. The server 112 may retrieve the medical note in response to receiving a request from a client device used by a registered user. The medical note may include predefined data fields for entry of medical data. These predefined data fields may be selected based on the underlying condition causing the referral. In some cases, the underlying condition is associated with a medical note code. For example, a medical note relating to an injury a hand, wrist, and/or shoulder injury may include prepopulate with areas to examine and/or appropriate tests associated with the underlying condition causing the referral. The server 112 may also automatically populate a portion of the template based on the contents of stored medical information 122 pertaining to the patient.

As shown in FIG. 12, a medical note may also include dictation data 1206. Server 112 displays the dictations entries associated with the underlying condition causing the referral. These dictation entries are displayed via both a text box and a selectable link associated with the audio file. The dictation files may be generated pertaining to patient reported data by selecting the selectable patient eDictation text/icon 1208 or pertaining to physician reported data by selecting the selectable physician eDictation text/icon 1210. Alternatively, dictation files are categorized as patient or physician reported by selecting the category from category drop down menu 1214 and selecting the text/icon 1212. In certain examples, a global dictation message is recorded and associated with the patient directly rather than with the underlying condition causing the referral. Generally, a global dictation is a dictation that is associated with all files in a patient record.

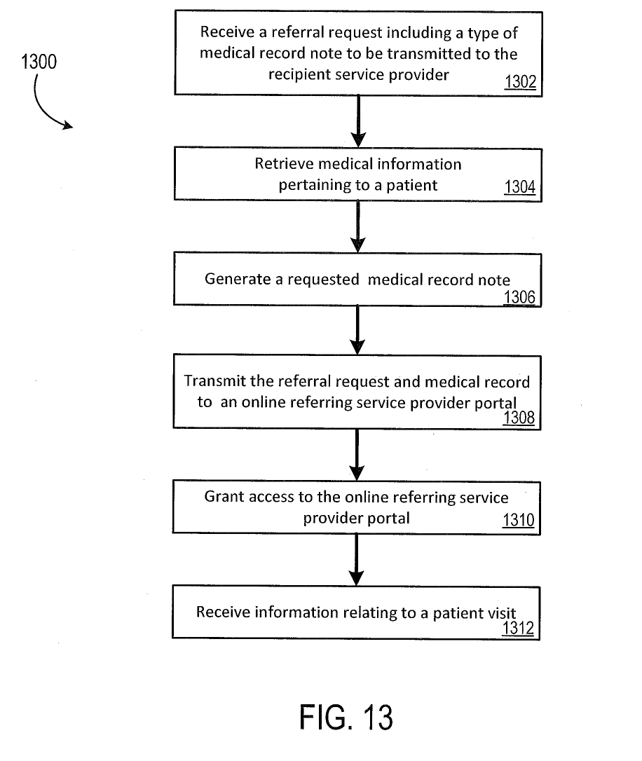

FIG. 13 is a flow chart of an example of a process 1300 for generating a referral process relating to a consumer, e.g., a patient. In operation, server 112 receives, from a client device, a referral request to refer a consumer, e.g., a patient, to an institution and/or a recipient service provider (1302). The server 112 retrieves medical information pertaining to the consumer, e.g., the patient, for inclusion with in the requested medical note (1304). The server 112 generates a medical note based on the medical information retrieved and the type of requested medical note (1306). In some cases, a requested medical note is a surgical note as discussed in U.S. application Ser. No. 14/077,392, which is hereby incorporated by reference. Server 112 transfers the referral request and the requested medical note to an online referring service provider portal (1308). The server 112 grants access an institution and/or recipient service provider access via one or more computing devices associated with the institution and/or recipient service provider to an online referring service provider portal (1310). The server 112 may receive any information entered by the institution and/or recipient service provider relating to a consumer visit (1312). Server 112 may store this new information as medical information pertaining to the consumer and/or update the EMR system with the newly acquired information. This information can then be accessible to all of the consumer's treating physicians.

Embodiments can be implemented in digital electronic circuitry, or in computer hardware, firmware, software, or in combinations thereof. An apparatus can be implemented in a computer program product tangibly embodied or stored in a machine-readable hardware storage device for execution by a programmable processor; and method actions can be performed by a programmable processor executing a program of instructions to perform functions by operating on input data and generating output. The embodiments described herein, and other embodiments of the invention, can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media and/or hardware storage devices for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method or parts thereof may use the “World Wide Web” (Web or WWW), which is that collection of servers on the Internet that utilize the Hypertext Transfer Protocol (HTTP). HTTP is a known application protocol that provides users access to resources, which may be data in different formats such as text, graphics, images, sound, video, Hypertext Markup Language (HTML), as well as programs. Upon specification of a link by the user, the client computer makes a TCP/IP request to a Web server and receives data, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments using web pages to allow a user to select options for a given component. Servers run on a variety of platforms, including UNIX machines, although other platforms, such as Windows 2000/2003, Windows NT, Sun, Linux, and Macintosh may also be used. Computer users can view data available on servers or networks on the Web through the use of browsing software, such as Firefox, Netscape Navigator, Microsoft Internet Explorer, or Mosaic browsers. The computing system can include clients and servers. A client and server are generally remote from each other and typically interact through a communication network. The relationship of client and server arises by virtue of computer programs running on the respective computers and having a client-server relationship to each other.

Other embodiments are within the scope and spirit of the description claims. Additionally, due to the nature of software, functions described above can be implemented using software, hardware, firmware, hardwiring, or combinations of any of these. Features implementing functions may also be physically located at various positions, including being distributed such that portions of functions are implemented at different physical locations.

The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

A number of exemplary embodiments of the invention have been described. Nevertheless, it will be understood by one of ordinary skill in the art that various modifications may be made without departing from the spirit and scope of the invention.

What is claimed is:

1. A method performed by one or more processing devices, comprising:
receiving, from a client device associated with a referring service provider, a referral request to refer a consumer to one or more of an institution and a recipient service provider, with the recipient service provider comprising a service provider to whom the consumer is referred;
wherein the referral request specifies a type of medical record note to be transmitted to the recipient service provider;
in response to the referral request, obtaining, from one or more data repositories, medical information to be included in the requested type of medical record note;
generating, based on the obtained medical information, the requested type of medical record note;
transmitting the referral request and the requested type of medical record note to one or more of a computing device associated with the institution and a computing device associated with the recipient service provider; and
granting access to an online referring service provider portal that enables input of information related to a visit of the consumer to one or more of the institution and the recipient service provider, with the input information promoting continuity of medical care between the referring service provider and one or more of the institution and the recipient service provider.

2. The method of claim 1, further comprising:
receiving, through the online referring service provider portal, information indicative of one or more files to be uploaded to the electronic medical record of the consumer.

3. The method of claim 1, further comprising one or more of:
receiving, through the online referring service provider portal, information indicative of one or more messages to be transmitted from the recipient service provider to the referring service provider; and
receiving, through the online referring service provider portal, information indicative of one or more messages to be transmitted from the referring service provider to the recipient service provider.

4. The method of claim 1, further comprising:
receiving, through the online referring service provider portal, information indicative of an outcome of an evaluation of the consumer by one or more of a service provider associated with the institution and the recipient service provider; and
causing an electronic medical record of the consumer to be updated with the received information.

5. The method of claim 1, further comprising:
granting access to the online referring service provider portal to the referring service provider.

6. The method of claim 1, wherein receiving the referral request comprises:
receiving, through the online referring service provider portal, the referral request.

7. The method of claim 1, further comprising:
generating information for a graphical user interface that is displayed through the online referring service provider portal, with the graphical user interface comprising:
information indicative of a listing of consumers being treated by the referring service provider;
for at least one of the consumers being treated by the referring service provider,
a first visual representation of a name of the least one of the consumers being treated by the referring service provider;
a second visual representation of a name of a recipient service provider to whom the least one of the consumers being treated by the referring service provider is referred; and
a third visual representation of an icon of a medical record note of the least one of the consumers being treated by the referring service provider, with selection of the icon causing the medical record note of the least one of the consumers being treated by the referring service provider to be displayed.

8. The method of claim 1, wherein obtaining the medical information comprises one or more of:
obtaining patient reported medical information, with the patient reported medical information being based on the consumer providing answers to one or more medical questionnaires;
obtaining physician reported medical information; and
obtaining electronic dictation medical information that comprises medical information that is generated through speech to text software.

9. The method of claim 1, further comprising:
generating information for a graphical user interface that when rendered on a client device displays:
a control, selection of which causes a recordation of speech information that is dictated by a medical provider of the consumer;
receiving text information that is converted from the dictated speech information and an identifier for the consumer; and
causing, based on the identifier, an electronic medical record of the consumer to be updated with the received text information.

10. The method of claim 1, further comprising:
generating information for a graphical user interface that when rendered on a client device displays:
a visual representation of an electronic medical record of the consumer; and
a control, selection of which causes (i) a recordation of dictation information that is dictated by a medical provider of the consumer, and (ii) the electronic medical record to be updated with the dictation information.

11. One or more machine-readable hardware storage devices storing instructions that are executable by one or more processing devices to perform operations comprising:
receiving, from a client device associated with a referring service provider, a referral request to refer a consumer to one or more of an institution and a recipient service provider, with the recipient service provider comprising a service provider to whom the consumer is referred;
wherein the referral request specifies a type of medical record note to be transmitted to the recipient service provider;
in response to the referral request, obtaining, from one or more data repositories, medical information to be included in the requested type of medical record note;
generating, based on the obtained medical information, the requested type of medical record note;
transmitting the referral request and the requested type of medical record note to one or more of a computing device associated with the institution and a computing device associated with the recipient service provider; and
granting access to an online referring service provider portal that enables input of information related to a visit of the consumer to one or more of the institution and the recipient service provider, with the input information promoting continuity of medical care between the referring service provider and one or more of the institution and the recipient service provider.

12. The one or more machine-readable hardware storage devices of claim 11, wherein the operations further comprise:
receiving, through the online referring service provider portal, information indicative of one or more files to be uploaded to the electronic medical record of the consumer.

13. The one or more machine-readable hardware storage devices of claim 11, wherein the operations further comprise one or more of:
receiving, through the online referring service provider portal, information indicative of one or more messages to be transmitted from the recipient service provider to the referring service provider; and
receiving, through the online referring service provider portal, information indicative of one or more messages to be transmitted from the referring service provider to the recipient service provider.

14. The one or more machine-readable hardware storage devices of claim 11, wherein the operations further comprise:
receiving, through the online referring service provider portal, information indicative of an outcome of an evaluation of the consumer by one or more of a service provider associated with the institution and the recipient service provider; and
causing an electronic medical record of the consumer to be updated with the received information.

15. The one or more machine-readable hardware storage devices of claim 11, wherein the operations further comprise:
granting access to the online referring service provider portal to the referring service provider.

16. The one or more machine-readable hardware storage devices of claim 11, wherein receiving the referral request comprises:
receiving, through the online referring service provider portal, the referral request.

17. An electronic system comprising:
one or more processing devices; and
one or more machine-readable hardware storage devices storing instructions that are executable by the one or more processing devices to perform operations comprising:
receiving, from a client device associated with a referring service provider, a referral request to refer a consumer to one or more of an institution and a recipient service provider, with the recipient service provider comprising a service provider to whom the consumer is referred;
wherein the referral request specifies a type of medical record note to be transmitted to the recipient service provider;
in response to the referral request, obtaining, from one or more data repositories, medical information to be included in the requested type of medical record note;
generating, based on the obtained medical information, the requested type of medical record note;
transmitting the referral request and the requested type of medical record note to one or more of a computing device associated with the institution and a computing device associated with the recipient service provider; and
granting access to an online referring service provider portal that enables input of information related to a visit of the consumer to one or more of the institution and the recipient service provider, with the input information promoting continuity of medical care between the referring service provider and one or more of the institution and the recipient service provider.

18. The electronic system of claim 17, wherein the operations further comprise:
receiving, through the online referring service provider portal, information indicative of one or more files to be uploaded to the electronic medical record of the consumer.

19. The electronic system of claim 17, wherein the operations further comprise one or more of:
receiving, through the online referring service provider portal, information indicative of one or more messages to be transmitted from the recipient service provider to the referring service provider; and
receiving, through the online referring service provider portal, information indicative of one or more messages to be transmitted from the referring service provider to the recipient service provider.

20. The electronic system of claim 17, wherein the operations further comprise:
receiving, through the online referring service provider portal, information indicative of an outcome of an evaluation of the consumer by one or more of a service provider associated with the institution and the recipient service provider; and
causing an electronic medical record of the consumer to be updated with the received information.
